(19) United States
(12) Patent Application Publication
(10) Pub. No.: US 2011/0014527 A1
(43) Pub. Date: Jan. 20, 2011

(54) POLYOXOMETALATE FLOW-CELL POWER SYSTEM

(76) Inventor: Leroy James Ohlsen, City of Gold Bar, WA (US)

Correspondence Address: OLYMPIC PATENT WORKS PLLC, P.O. BOX 4277, SEATTLE, WA, 98104, US

(21) Appl. No.: 12/839,314

(22) Filed: Jul. 19, 2010

Related U.S. Application Data
(60) Provisional application No. 61/226,373, filed on Jul. 17, 2009.

(51) Int. Cl. H01M 8/06

(52) U.S. Cl. 429/408

(57) ABSTRACT

Embodiments of the present invention relate generally to redox flow batteries and, more specifically, to flow batteries that employ electron-ferrying redox compounds made from polyoxometalates (“POMs”). Embodiments of the present invention employ flow-battery technology that combines the fast electrochemical reaction of a battery with the fuel flexibility of a fuel cell to meet next-generation energy needs of a variety of power applications, including portable electronics used in military and commercial applications and large power modules that provide 550 W or more. To obtain a high-power-density stack, a reduced form of liquid POM is fed to the stack of cells, in certain embodiments of the present invention, where the reduced form of liquid POM is efficiently oxidized into liquid products at the anodes. Air is fed and reduced at the cathodes, generating water as a byproduct.

### CROSS-REFERENCE TO RELATED APPLICATION

This application claims the benefit of Provisional Application No. 61/226,373, filed Jul. 17, 2009.

### TECHNICAL FIELD

The present invention relates generally to redox flow batteries and fuel cells and, more specifically, to flow batteries that employ electron-ferrying redox compounds made from polyoxometalates.

### BACKGROUND

The ever-growing expectations for more power and performance from mobile electronic products has created a large and growing need for energy-storage systems that are compact, lightweight, and powerful, with the demand for longer battery life increasing faster than the capacity of the technology to improve. Though lithium-ion (Li-ion) is the dominant technology for powering today's mobile devices, many experts believe the technology has become mature. Although electronic manufacturer's designers are constantly developing improved power-saving designs, and although second and third generations of new features do tend to demand less power, there are always more features to add which typically (at best) cancel out any incremental progress obtained with design refinements of previous features. For instance, one vendor has announced the release of a “24-hour battery” laptop, but the laptop can only run an older-generation operating system because newer operating systems are less power efficient. One vendor is attempting to boost battery life by replacing the LCD display in laptops with an LED display, which can extend, by four hours, the battery life. Although these improved battery-life numbers may be judged impressive, they are attained in exchange for sacrificing the most basic computer programs and memory performance and are primarily realized via innovations that are in no way related to actual battery improvements.

Increasing battery energy density by up to 25% through new electrode materials will not deliver a substantial corresponding increase in runtime. For example, a notebook PC's runtime would increase from three hours to three hours and 45 minutes, barely keeping pace with the increased power demand for new features. Internet media functions and handwriting/speech recognition will place even more strain on battery systems.

The US military represents a significant segment of the worldwide portable device market. The US military has a pressing need for lighter and more compact electric power sources for soldiers, robotics, and other emerging applications. From essential communication support to integrated thermal weapon sights and night vision capability, batteries have served as the primary power source for the vital battlefield functions on which soldiers depend. With recent advances in the modern soldier's war-fighting capabilities, the demand for longer battery life has increased faster than the capacity of the technology to improve. As a result, a soldier carries multiple batteries of various chemistries that impact and complicate the logistic supply chain, and their performance demands in terms of long power-source life, light weight, and small volumes provide key drivers and specifications for technical advances.

Increasing world energy consumption within the next 50 years, coupled with growing concerns over climate change, have brought increasing awareness of the need for efficient, clean, and scalable energy modules that can satisfy the needs for a broad spectrum of applications.

TABLE 1
Target Electrical Energy Module Specifications:
Present Devices that Meet Specifications.

| Current Energy Module Type | | | Li-ion Battery | Flow Battery | Fuel Cell |
|---|---|---|---|---|---|
| Power Module | >1-2 | kW | Not Safe! | Yes | Yes |
| Energy Density | >400 | Whr/L | Yes | No | Yes |
| Power Density | 2,000 | W/L | Yes | No | No |
| Max. Power Duration | 5 to 10 | minutes | Yes | Yes | Yes |
| Cycle Life | >1,000 | hrs | No | Yes | Yes |
| Shelf Life | 5 | year | Yes | Yes | Yes |
| Temperature | 150 (51) | ° F. (° C.) | Yes | Yes | Yes |
| Response Time | 0.1 | second | Yes | Yes | No |

Battery and fuel-cell technologies have largely sought to reduce both imports of energy from foreign sources and energy-related emissions largely through improvements in the energy-conversion efficiency. An electrical energy module (EEM) system sized for 1 to 500 kW applications would need to meet the performance metrics outlined in 1 for successful commercialization. However, today's batteries, fuel cells, and other storage devices do not yet meet all the specifications.

With one of the best battery-energy densities (128 to 400 Whr/L), power densities in the 250-4600 W/L range, no memory effect, and a slow loss of charge when not in use, Li-ion is the dominant technology for powering today's mobile devices. In addition, Li-ion batteries are growing in popularity for defense, automotive, and aerospace applications due to their high energy density. However, because of key safety concerns and limited cycle life, Li-ion batteries are not suitable for large kW-sized EEMs. In addition, most Li-ion batteries fall short of the minimum 1,000-hour target. Their operation lives are generally about 600 to 800 hours. Safety is a concern, and since Li-ion batteries can overheat and explode under certain conditions, this is one of the primary reasons why Li-ion has not entered into the hybrid vehicle market in the 1-2 kW range. Approximately 1% of Li-ion batteries have been subject to recalls. Lithium-ion batteries can rupture, ignite, or explode when exposed to high-temperature environments, such as an area that is prone to prolonged direct sunlight, or from short-circuiting. During the past decade there have been numerous recalls of lithium-ion batteries in cellular phones and laptops due to overheating problems. One example is the mid-2006 recall of approximately 10 million Sony batteries used in many laptops, blamed on internal contamination with metal particles. In December 2006, Dell recalled approximately 22,000 batteries from the U.S. market, and in March 2007, Lenovo recalled approximately 205,000 9-cell lithium-ion batteries due to risk of explosion. In August 2007, Nokia recalled over 46 million lithium-ion batteries, warning that some of them might overheat and possibly explode.

Flow batteries are beginning to become of interest to utilities in a number of applications requiring buffers for variability in load and supply of electricity. For example, several multi-kW systems have been built and tested by SEI and Mitsubishi Chemical. At least two 8 MW systems have been put into place by TEPCO in Japan. These are primarily used for load leveling, where the battery is used to store inexpensive night-time electricity or to provide electricity when it is more costly. These systems are also used to store energy from renewable sources such as wind or solar for discharge during periods of peak demand. In addition, they may be utilized for peak shaving, where spikes of demand are met by the battery, and for uninterrupted power supplies (UPS), where the battery is used if the main power fails to provide an uninterrupted supply. Modern flow batteries generally employ two-electrolyte systems in which the two electrolytes are pumped through the cell. The major advantages of this system are (1) electrical storage capacity limited only by the capacity of the electrolyte storage reservoirs; (2) long cycle life (because there are no phase changes); (3) quick response times; (4) no need for “equalization” charging (in common with nearly all batteries); and (5) low maintenance and high tolerance for overcharge/overdischarge. Vanadium redox and zinc-bromine flow batteries are currently available while other battery chemistries are being explored. While flow batteries provide an opportunity to meet requirements for integrating renewable energy, substantial improvements are needed before such batteries can reach widespread deployment. The major disadvantage to these battery systems is the low energy density, similar to lead acid batteries (˜66-104 Whr/L).

The promise of fuel cell technology, along with the promise of increased efficiency over diesel or gas turbine engines (see FIG. 1), has been on the horizon for decades, yet today's best fuel-cell systems are still not logistically practical for routine civilian or military applications. Before a fuel cell can be integrated into a commercial design, a number of challenges are yet to be resolved. These include increasing the energy efficiency (fuel reforming) and power density of the system, and decreasing start-up/response time.

The energy efficiency of a practical fuel cell is somewhat diminished by the energy needed to convert high-energy-density fuels, such as bio-diesel and diesel fuels, into hydrogen-rich gas needed by the fuel cell, and by the need to scrub sulfur and the reforming products from the fuel. Effective use of these fuels in fuel-cell applications requires removal of sulfur species (organosulfur compounds) to below 0.1 ppm. Low-temperature fuel cells require clean (essentially pure) hydrogen feed to prevent the poisoning of the anode catalyst. Even the more robust high-temperature fuel cells (e.g., solid oxide fuel cells) are poisoned with low levels of sulfur. Desulphurization units add complexity to the overall fuel-cell system and extra weight, which leads to the reduction of overall system efficiency.

Current fuel cells, when coupled with their reformers, sulfur scrubbers, and other auxiliary equipment, are considerably less power dense than gas turbines or diesel. Current state-of-the-art stationary power fuel cells are constructed to operate with a commercial electrical grid and often need many minutes to startup and to respond to changes in load with a time lag measured in seconds. A complete system should be able to respond to load changes in less than a tenth of a second. The need for reforming only adds to the startup and delayed responsiveness of the system.

### SUMMARY

In brief, embodiments of the present invention relate generally to redox flow batteries and, more specifically, to flow batteries that employ electron-ferrying redox compounds made from polyoxometalates (“POMs”). Embodiments of the present invention employ flow-battery technology that combines the fast electrochemical reaction of a battery with the fuel flexibility of a fuel cell to meet next-generation energy needs of a variety of power applications, including portable electronics used in military and commercial applications and large power modules that provide 550W or more. The POM-based batteries of certain embodiments of the present invention are referred to as “flow cells.” Unlike the large and cumbersome fuel-cell systems developed to date, flow cells are as responsive and small as existing batteries but use a fuel with a higher energy density than hydrogen storage media or methanol. Furthermore, flow cells that represent certain embodiments of the present invention are designed to be (1) recharged like a battery using an outlet power socket, or (2) recharged with a high-energy-density fuel for longer runtimes while keeping system power density high to enable miniaturization. In high-power embodiments of the present invention, small alcohols, such as propanol or ethanol, are used as fuel in certain embodiments of the present invention. In certain lower-power embodiments of the present invention, alcohols, biodiesel, diesel, or military logistic fuels are used.

To obtain a high-power-density stack, a reduced form of liquid POM is fed to the stack of cells, in certain embodiments of the present invention, where the reduced form of liquid POM is efficiently oxidized into liquid products at the anodes. Air is fed and reduced at the cathodes, generating water as a byproduct. The POM-based flow cells that represent certain embodiments of the present invention can be recharged conventionally, like a battery, or reacted with a liquid fuel. The POM stack is not deleteriously impacted by the presence of common fuel impurities, such as the sulfur found in logistic fuels. Even were the sulfur in the fuel stream able to adsorb onto the electrode surface, the electrode's electronic conductivity does not decrease significantly. Thus, the electrochemical activity (the ability to capture electrons from the POM) of the flow cells that represent embodiments of the present invention are not significantly impacted by the presence of sulfur. Extra POM can be carried in a reservoir for the stack.

### BRIEF DESCRIPTION OF THE DRAWINGS

FIG. 1 contrasts the efficiency vs. system size of fuel cells over diesel or gas turbine engines.

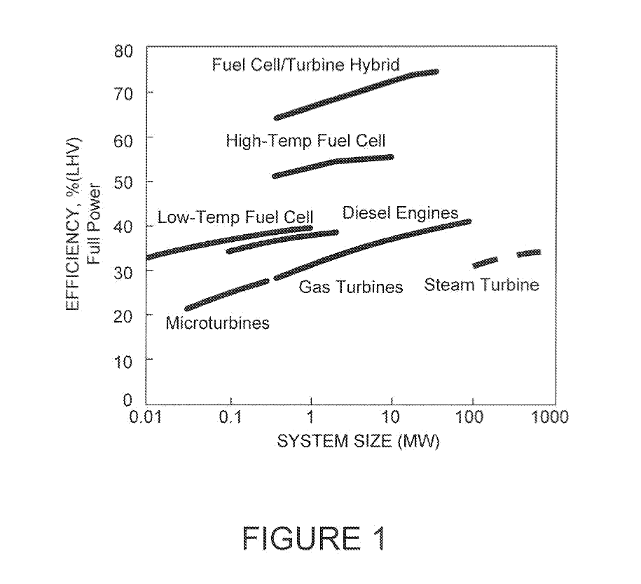

FIG. 2 represents a pictorial side cross-sectional view of an example of a single POM Flow Cell that represents one embodiment of the present invention.

FIG. 3 represents a pictorial view of one example reaction that occurs on the catalyst surface inside the POM Flow Reactor that represents one embodiment of the present invention.

FIG. 4 shows preliminary half-cell anode polarization of H₅PMo₁₂O₄₀ with Pt/Ru catalysts at room temperature according to one embodiment of the present invention.

FIG. 5 shows the redox potentials of other POMs with varying composition according to one embodiment of the present invention.

FIG. 6 represents a simple schematic of the envisioned POM-based flow cell system according to one embodiment of the present invention.

FIG. 7 shows a volume breakout chart of one embodiment of the present invention.

FIG. 8 represents a pictorial side cross-sectional view of an example of a gas-removal subcomponent or module according to one embodiment of the present invention.

FIG. 9 represents a pictorial view of an example of an osmosis water recovery subcomponent or module according to one embodiment of the present invention.

FIG. 10 shows the synthesis flow diagram of carbon-supported PtₓPd_{y} and PtₓRu_{y} nanoparticles to be used in the POM reactor and the anodes of the stack of flow cells according to one embodiment of the present invention.

FIG. 11 shows the fabrication of a membrane electrode assembly (“MEA”) for single POM flow cells according to one embodiment of the present invention.

FIG. 12 shows an exploded view of a single POM flow cell according to one embodiment of the present invention.

### DETAILED DESCRIPTION

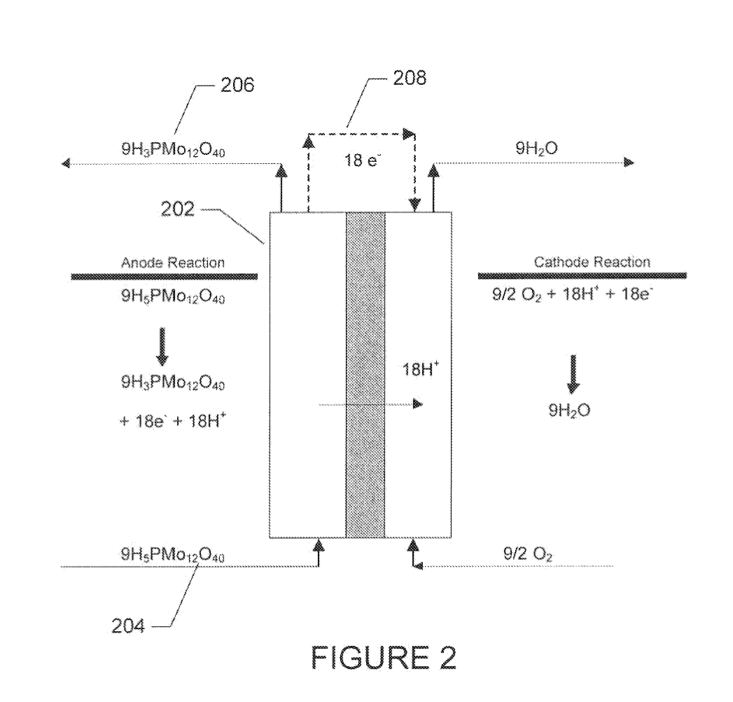

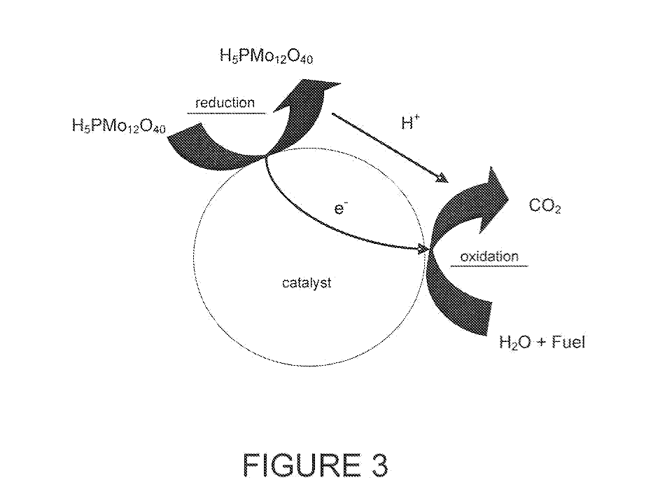

As noted above, embodiments of the present invention relate generally to redox flow batteries and, more specifically, to flow cells that employ electron-ferrying redox compounds made from polyoxometalates (“POMs”). A simple representation of a single flow cell according to one embodiment of the present invention is shown in FIG. 2. The POM chemistry takes place principally at the anode 202, where fuels are oxidized. At the flow cell's anode, a reduced form of POM 204 is oxidized and releases electrons 208. Here, H₅PMo₁₂O₄₀ is the reduced form of POM (the reactant) and H₃PMo₁₂O₄₀ 206 is the oxidized form of POM (the product). To continuously operate the flow cell, the oxidized form of POM exiting the anodes is regenerated by reacting the oxidized form of POM with the primary fuel in the POM reactor. A simple representation of the reaction that occurs inside the POM flow reactor, according to one embodiment of the present invention, is shown in FIG. 3.

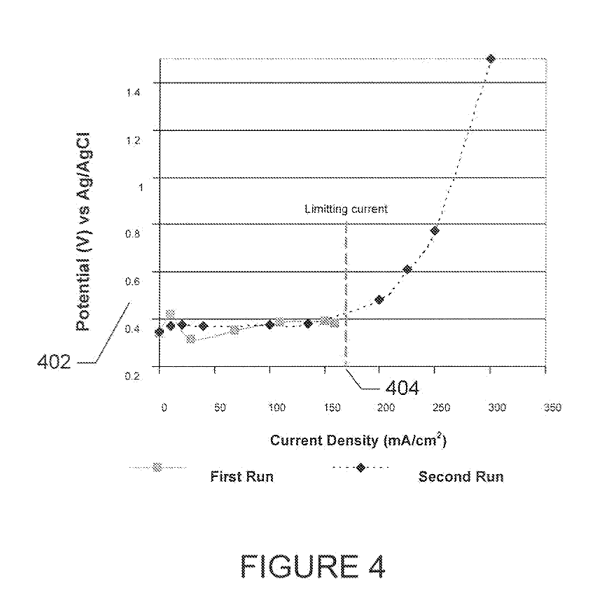

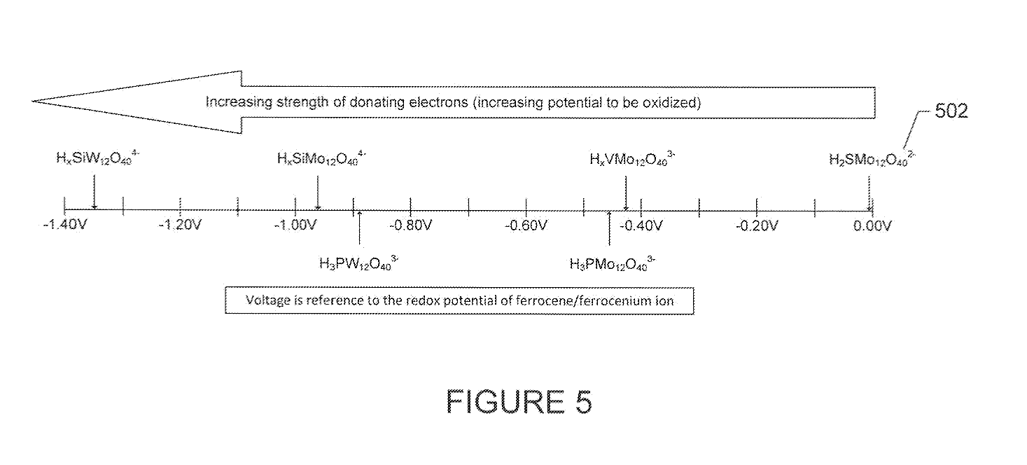

Preliminary half-cell results, according to one embodiment of the present invention, are shown in FIG. 4. In this test, a conventional Pt/Ru catalyst was used to oxidize 0.20 to 0.30 M H₃PMo₁₂O₄₀ at room temperature. FIG. 4 shows that H₅PMo₁₂O₄₀ starts to oxidize at the onset potential of 0.4 V vs. Ag/AgCl 402, and very little overpotential is needed to produce 150 mA/cm² 404 of current output at room temperature. The onset potential can be significantly reduced by either modifying the chemical composition of POM or solvent type. FIG. 4 clearly indicates that the POM is electrochemically very active chemically over Pt/Ru catalysts. To achieve maximum cell and POM reactor performance, other POMs with higher reduction potentials than H₃PW₁₂O₄₀, such as H₃PMo₁₂O₄₀ and H₃VMo₁₂O₄₀ can also be used. According to FIG. 5, H₂SMo₁₂O₄₀ 502 provides the highest efficiency and best electrochemical stabiliy because its reduction potential is highest (−0.01 V vs. ferrocence/ferrocenium ion reference electrode). However, because its reduction potential is so high. H₂SMo₁₂O₄₀ may not be the best POM solution for many applications, i.e., its reduced form is so stable that it cannot be easily oxidized at the anode of POM flow cell. In general, POM redox potentials are strongly dependent on the type of transition metal and non-metal cations used in them (see FIG. 5).

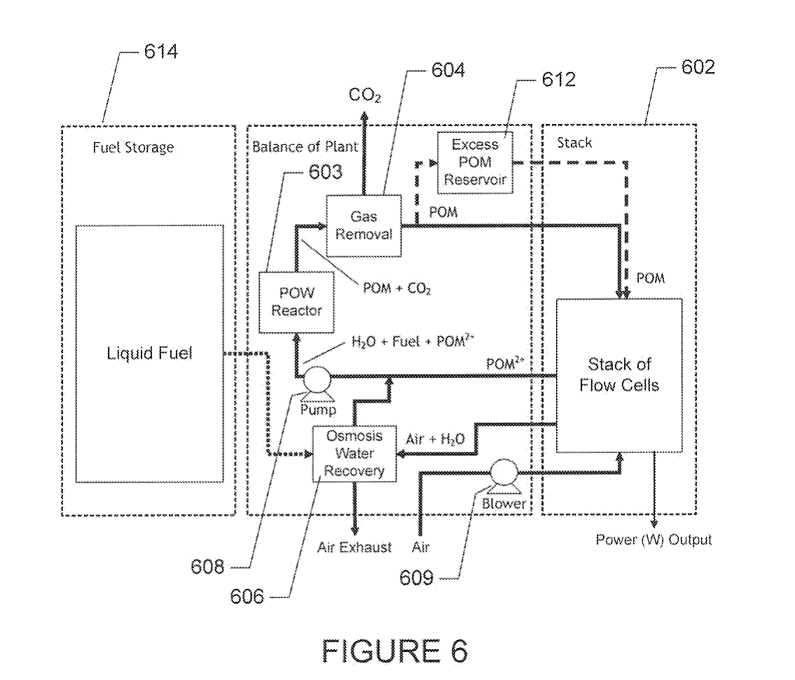

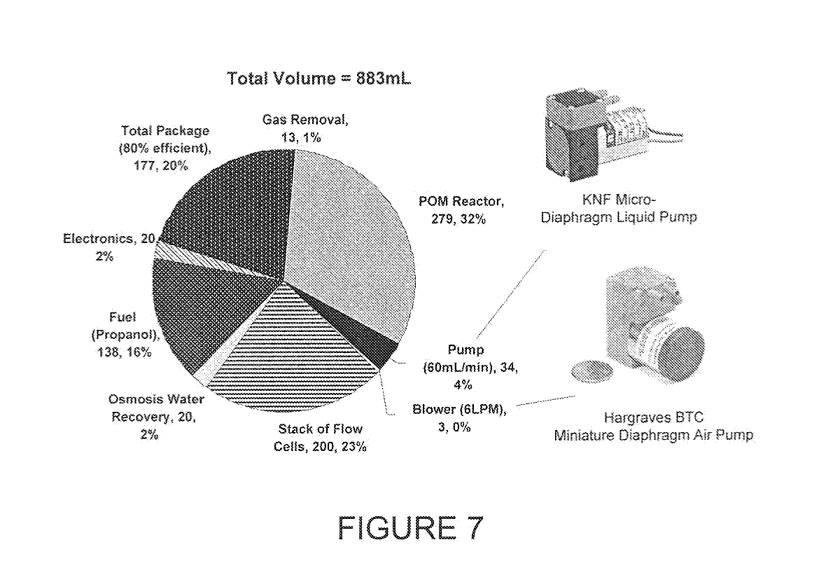

FIG. 6 shows a simple schematic of the overall POM flow cell system in one embodiment of the present invention. In this embodiment of the present invention, many different alcohols and hydrocarbons can be used as the fuel as long as the POMs can efficiently capture their electrons. In certain embodiment of the present invention, these include the flow cell stack 602, alternative recharging capability 603, gas removal 604, osmosis water recovery 606, pump/blower 608-609, excess POM reservoir (for startup/load responsiveness) 612, cartridge 614, and packaging. For example, a breakdown chart is shown in FIG. 7 that shows how these components fit into an application which has a volume of 883 mL.

In an application of the present invention, i.e., a 20-watt output system, the re-circulating flow rate of POM should be just under 60 mL/min. A pump that pumps up to 100 mL/min with 0.5 W of power is suitable for this application. Likewise, BTC pumps are adequate to provide 6 LPM of air flow, which is 2X the required stoicheometry for a 20 W POM flow cell system. These pumps both use less than 10% of the system volume and have demonstrated over 20,000 hours of operation, which exceeds a target of 3,000 hours. Most Li-ion batteries have operation lives of about 600 to 800 hours.

Since either water or air may be used to fully convert the fuel into carbon dioxide in the POM reactor, either air or water is added to the fuel stream that is injected into the POM reactor. When water is added to the fuel it is also desirable not to have to carry extra water with the fuel; neat or concentrated fuel is desirably the only fuel fed to a commercial POM flow cell system. Fortunately, a source of excess water is produced as a by-product on the cathode(s) from the stack of flow cells. The water is removed from the exhaust air stream with a small subcomponent. In one embodiment of the present invention, a compact water-management module is used that is based on the concept of osmosis where the exiting humidified air is brought into contact with the incoming concentrated fuel, creating an osmotic driving force to pull the water from the air stream. In addition, for military applications, the outside temperature and humidity needs to have little or no affect on the means for removing water from the exhaust air stream of the POM flow-cell system.

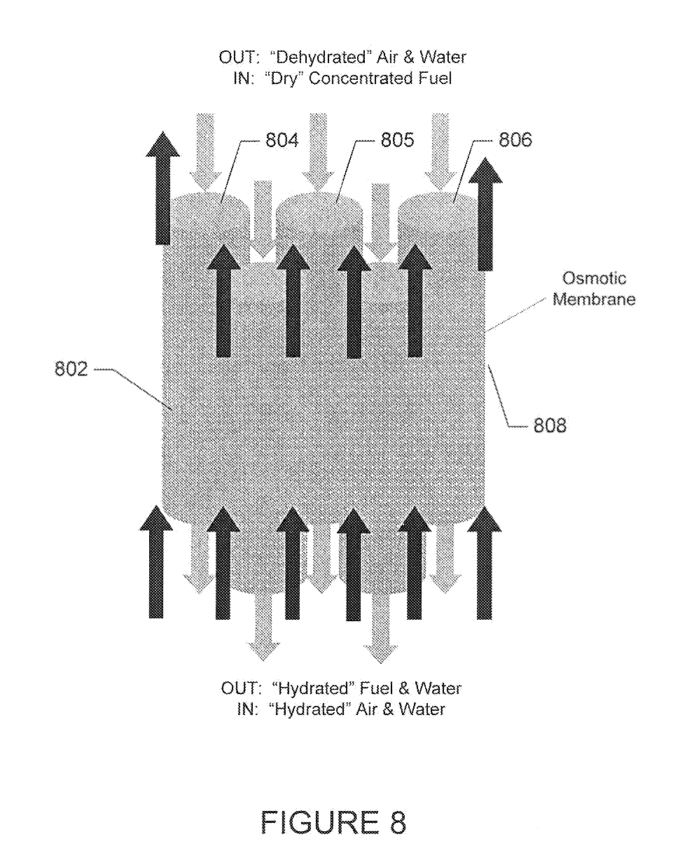

The osmosis-water-recovery subcomponent or module is based on a hollow fiber contactor. Moisture is removed from the cathode exhaust gas stream by bringing that stream into a module containing hollow fibers as illustrated in FIG. 8. The outer surface 802 of the hollow fibers 804-806 contains a hydrophilic layer that captures or wicks the water from the humid exhaust gas flow via capillary force without the need to remove sensible heat from the air stream (i.e., the moisture may be removed from the gas stream at ambient temperatures). An osmotic layer 808, such as a semi-permeable membrane, is disposed on the inside surface of the hydrophilic layer, and the fuel having no water initially therein is disposed adjacent to this osmotic layer. An osmotic driving force, resulting from the water concentration gradient across the osmotic layer, transports the condensed water from the hydrophilic layer through the thickness of the osmotic layer and into the fuel. The osmotic layer also inhibits the fuel from flowing into the hydrophilic layer.

Since carbon dioxide is a by-product from the reaction(s) occurring in the POM reactor, this gas is removed from the liquid stream prior to the stack of flow cells. When the carbon dioxide gas is not removed quickly, it becomes trapped over the reaction surface catalysts within the anode(s) and thus reduces the reaction rate by limiting reactant access. Furthermore, the generation and existence of gas bubbles entrained within a fluid flowstream tend to cause, among other things, increased pressure drops and flow instabilities (as compared to liquid only conditions). The more area with gas residence exists in the device, the higher the back pressure, which causes more gas to stay or to be pushed into upstream components. As such, it is necessary to remove the gas as quickly as possible and as close to its generation site as possible.

In one embodiment of the present invention, a simple mechanism to separate gases from liquids makes use of a hydrophilic membrane (and/or as capture structures) that wicks the fluid from the gas stream with little pressure/flow resistance. This avoids the wetting problem that commonly occurs when a hydrophobic membrane loses its hydrophobic properties in the presence of alcohols.

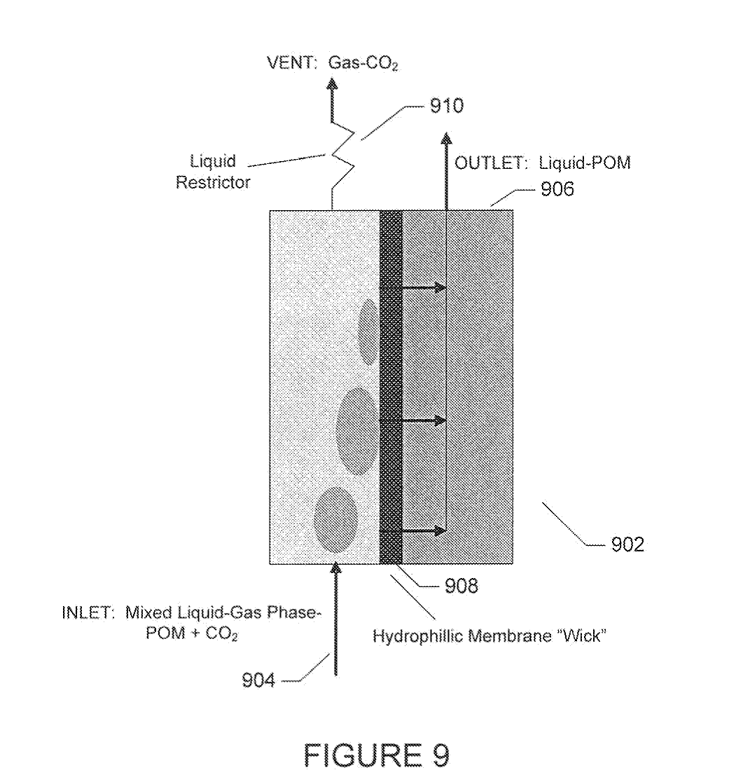

A simple design layout according to one embodiment of the present invention is illustrated in FIG. 9. In FIG. 9, the gas removal sub-component or module 902 is a set of plates, typically two flow field plates, sandwiched together enclosing a membrane permeable to liquids. The POM reactor output stream 904 feeds into one of the plates. The other plate has an exit hole for the decarbonated liquid 906 permeated through the wick 908. The wick is a barrier between the flow fields. Liquid phase is sucked into the wick from the two-phase flow via capillary force and transported away in the liquid channel behind the wick, while gas flows further down the channel and through a liquid restrictor 910 to a vent to the outside environment. The fluid restrictor has a higher resistance to liquid flow than the hydrophilic membrane.

The hydrophilic membrane has a density of millions of interconnected pores per square centimeter to evenly and completely wet the wick and hence to prevent the gas break-through when gas slug contacts the wick surface. The average pore size is generally between 0.5 to 20 microns in diameter. When fully wetted, the wick is substantially restrictive to gases present in the POM reactor output stream. The uneven wetting or distribution of liquid across the inlet surface of the wick is undesirable because this type of irregularity may cause uneven pressure drops across the wick material surface and gas break-through and in turn the gas entrainment in the POM flow cell system. The material is hydrophilic and chemically compatible with POM chemistry.

Both the gas removal and osmosis water recovery subcomponents are passive systems. Consequently, the gas removal and osmosis water recovery modules, by themselves, do not draw power; hence, both modules improve the overall efficiency of the POM flow cell system. In addition, the module is small in size and can easily be stacked and integrated with the POM reactor or system.

### EXAMPLE 1

### Catalyst Nanoparticle Preparation for the Pom Flow Cell and Pom Reactor

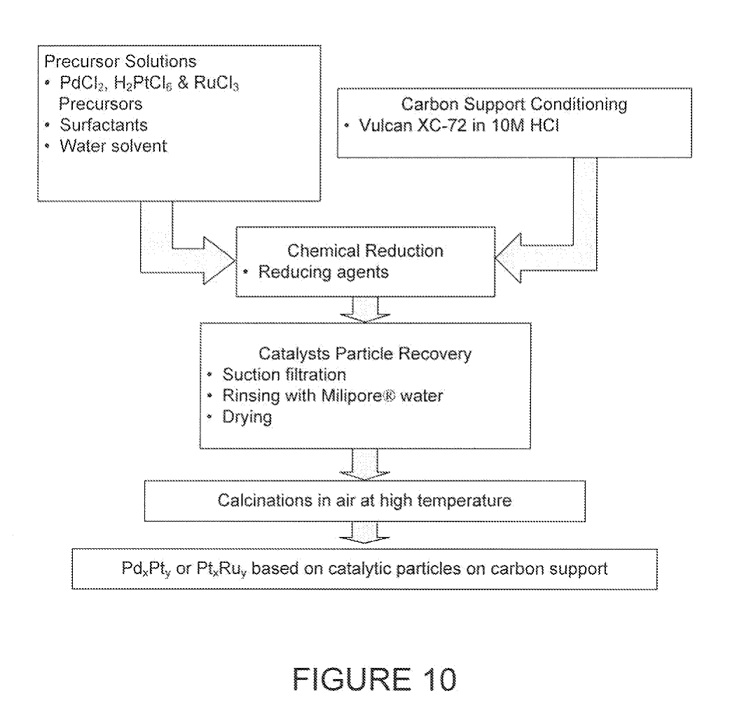

Since the electrochemical reaction occurs only at the catalyst surface, it is important to increase the available surface area per volume of catalyst used. Thus, to achieve high catalyst utilization, nanoparticles are synthesized on a carbon support. The carbon support prevents the nanoparticles from aggregating and provides a high electronic conductivity with good physical stability. The carbon-supported Pt and Pd nanoparticles and different compositions of noble-metal alloys (PtₓPd_{y} and PtₓRu_{y}) can be synthesized using a co-precipitation method. FIG. 10 shows a flow diagram of the catalyst-preparation steps, based on the co-precipitation method, according to one embodiment of the present invention.

### EXAMPLE 2

### Catalyst Ink Preparation for the Pom Flow Cell and Pom Reactor

First, an effective POM oxidizing electrode surface is prepared. To reduce the overpotential and to effectively oxidize POM, the anode electrode possesses both the electronic and ionic conducting networks. To fabricate a direct POM flow cell with such electrode properties, the anode catalyst ink is prepared by mixing the selected catalytic particles from Example 1 with Nafion® solution and water. This ink is applied onto the polymer membrane and dried to form the electrode surface. In this electrode surface, Nafion® provides an ion-conducting network, while the catalyst particles provide the electronic conducting network for a direct POM flow cell. However, if too much Nafion® solution is added to the catalyst particles during the ink-preparation step, the catalyst particles cannot maintain a good electronic conducting network, because each particle is separated by an excess amount of Nafion® polymer. On the other hand, an insufficient amount of Nafion® solution in the catalyst ink leads to a poor ionic conducting network within the electrode. Thus, the mixing ratio between the catalyst particles and Nation® solution needs to be optimized or nearly optimized for the direct POM flow cell. Since POM's electrons and protons are completely separated from each other before any electrochemical reactions occur, a very small amount of Nafion® content (just enough to bind the catalyst particles onto the polymer membrane) is used for the direct POM flow cell's anode electrode. Adjusting the appropriate Nafion® content to the direct POM flow cell leads to a more efficient utilization of the catalyst.

The cathode ink is prepared similarly to the anode ink using commercial Pt catalyst. Since the cathode electrode is very similar to the air-breathing cathode electrode of conventional air-breathing fuel cells, use an existing protocol for preparing the cathode catalyst ink.

### EXAMPLE 3

### Membrane Electrode Assembly Preparation for the Pom Flow Cell

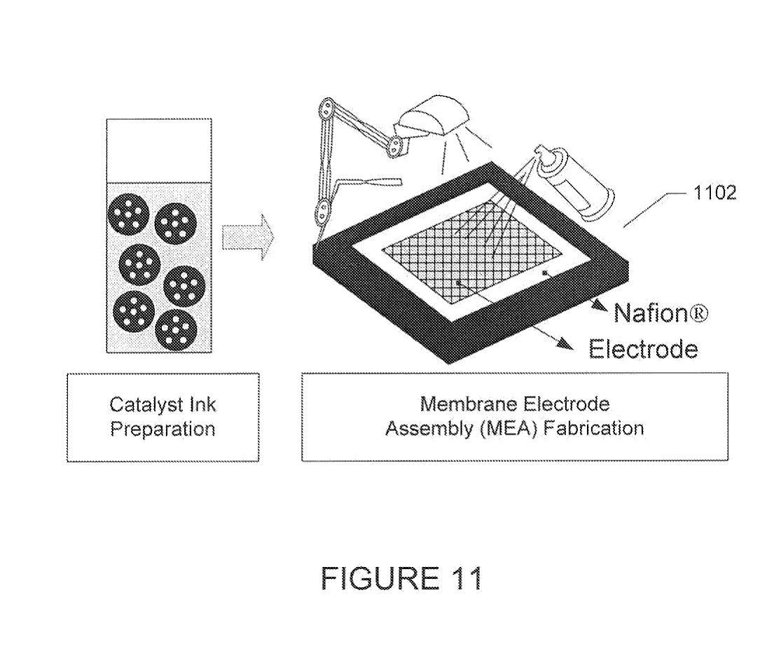

Both the anode and cathode electrodes are fabricated by air brushing the inks from Example 2 onto a Nafion® polymer membrane. Nafion® membranes with thicknesses of 2, 5, and 7 milli-inches can be used to fabricate membrane electrode assemblies (MEAs). To secure the membrane while spraying the inks, the membrane is placed on a heated vacuum table 1102, as shown in FIG. 11. This elevated temperature will improve the drying rate of the excess water. After applying and drying the cathode ink first on one side of the membrane, the membrane is turned over for application and drying of the anode ink. Since POMs consist of large anion clusters with balanced cations, i.e., protons, there is a large electrical repulsion between this anion and the sulfonic acid groups within the Nation® membrane. Hence, a large diffusive flux of POM from the anode to the cathode of the flow cell through the Nafion® membrane is not seen. A very thin membrane is adequate without losing any performance when the POM concentration is not too high (i.e., greater than 50% of fuel solution).

### EXAMPLE 4

### Anode Reactant Diffusion Layer Preparation for the Pom Flow Cell

Unlike H₂ PEM fuel cells, the POM flow cell uses an aqueous-based POM fuel. Thus, the conventional Teflon®-based reactant diffusion layers (RDLs) repel the POM fuel solution. To maintain a sufficient mass transport of POM into the electrode, the POM flow cell is partially flooded by the fuel solution. However, the RDL is not too hydrophilic so as to completely flood the electrode. If the POM concentration is too high, say, greater than 50 wt %, its crossover flux through the Nafion® membrane can be increased sufficiently high to create a large mixed potential at the cathode and reduce the overall cell efficiency. If POM “crossover” is an issue at its high concentration, the flow cell is operated using a medium, concentration of POM solution. For such medium POM concentrations, a sufficient amount of water-proof Teflon® coating is used. The RDL's surface properties are adjusted to attract enough POM fuel solution without trapping water. Various RDLs with different degrees of hydrophobic and hydrophilic properties can be adjusted by varying the exposing time of carbon cloth under the oxygen plasma or amount of Teflon® coating applied to the carbon cloth. The RDL with a slightly higher hydrophilic property than a regular carbon cloth wets the anode electrode with enough of the POM fuel solution while preventing the electrode from retaining excess water.

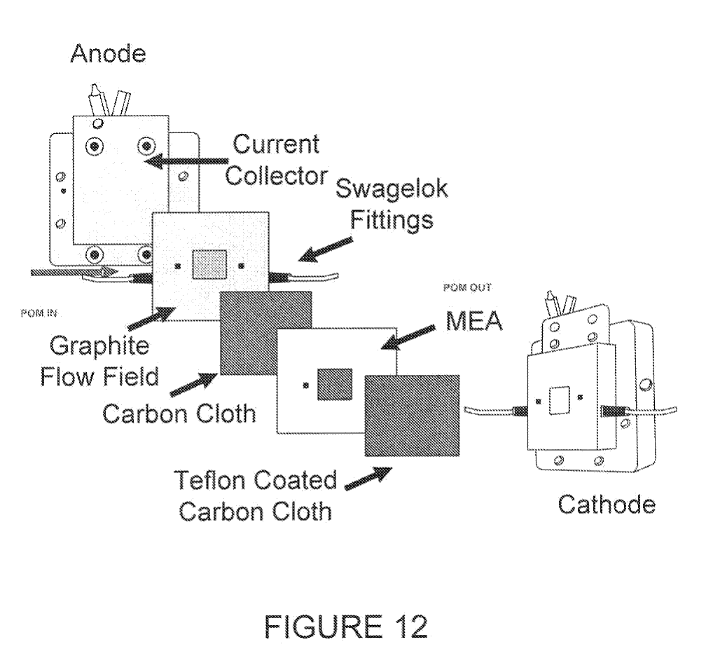

A POM flow cell is assembled as shown in FIG. 12 according to one embodiment of the present invention. To distribute the POM and oxygen on the anode and cathode electrodes, RDLs will be placed on the electrodes.

While certain embodiments of the present invention have been described in the context of the embodiments illustrated and described herein, the present invention may be embodied in other specific ways or in other specific forms without departing from its spirit or essential characteristics. Therefore, the described embodiments of the present invention are to be considered in all aspects as illustrative and not restrictive.

1. A polyoxometalate flow-cell power system comprising:
a polyoxometalate-based anode; and
a cathode that produces water.
